(19) United States
(12) Patent Application Publication
(10) Pub. No.: US 2007/0133775 A1
(43) Pub. Date: Jun. 14, 2007

(54) Method for reducing the cost of handling incoming/outgoing phone calls

(75) Inventor: Yair Winkler, Caesaria (IL)

Correspondence Address: Kevin D McCarthy;Roach Brown McCarthy & Gruber, 1620 Liberty Building, Buffalo, NY, 14202, US

(73) Assignee: FESTIN ENTERPRISES CORP., NOTORIAT 4 DER STADT (PA)

(21) Appl. No.: 10/559,025

(22) PCT Filed: Jun. 2, 2004
(86) PCT No.: PCT/IL04/00467

§ 371 Date: Jul. 3, 2006

(30) Foreign Application Priority Data
Jun. 2, 2003 (IL) 156271

(51) Int. Cl. H04M 7/00

(52) U.S. Cl. 379/220.01

(57) ABSTRACT

A method and system for reducing the cost of handling incoming/outgoing calls are disclosed. A plurality of communication centers deployed in a different geographical region and granted permission to use the receiving and transmitting infrastructure of a corresponding service provider are employed. A default communication center routes incoming/outgoing calls associated with a given subscriber to a distant communication center via an optimal path through the infrastructure of each of said service providers. The optimal path is selected after comparing the transmission time and cost of call for a plurality of possible communication paths.

### FIELD OF THE INVENTION

The present invention relates to the field of telecommunication. More particularly, the invention relates to a method for reducing the cost of handling incoming/outgoing phone calls by deploying communication centers in different geographical locations which determine an optimal path for calls, routing them through existing infrastructure of service providers.

### BACKGROUND

Voice mail is widely used in business and personal applications as a means for recording and retrieving a voice message when the intended recipient of the message is not accessible, e.g. the intended recipient is engaged in a telephone conversation or is distant from his telephone. A conventional voice mail system, generally comprising a specialized computer, stores each message within a database in such a way that subscribers are able to retrieve their messages by accessing a password.

Many users have access to three different voice mailboxes: one for personal messages, one for business-related messages and one for recording messages transmitted via a cellular network. In order to retrieve a message, the user needs to access each of the mailboxes, usually by initiating a call via an appropriate telephone network, resulting in inefficient time utilization and added expenses. The expenses for accessing the voice mailbox associated with a cellular telephone are further increased due to the greater cost of airtime, particularly for a traveler abroad, relative to the cost of calling via a landline telephone network. Travelers also encounter added costs when placing a call from a telephone at an instantaneous location to their home, business, or to any other desired phone number. These costs are primarily due to the increased number of communication lines, switching offices and employees needed to provide speedy and effective telephone service relative to a local landline call. The high overhead associated with more expensive long-distance or oversea calls is borne by telephone callers as fixed costs.

It is an object of the present invention to provide a method for accessing multiple voice mailboxes from a single telephone, with reduced costs.

It is an additional object of the present invention to provide a method for reducing the cost of placing a long distance call via a landline or cellular network.

It is an additional object of the present invention to provide a method for reducing the cost of a call transmitted via a cellular network, particularly for the purpose of retrieving messages from a voice mailbox.

It is an additional object of the present invention to provide a method for a traveler abroad to access his voice mailbox and/or to communicate via a telephone network with a desired party by placing a local telephone call.

It is a further object of the present invention to provide a method for reducing the permanent overhead associated with phone calls.

It is still another object of the present invention to provide a method for reducing time utilization and cost associated with phone calls normally directed to a call center.

It is yet another object of the present invention to provide an alternate last mile communication path to the cellular telephone of a subscriber.

Other objects and advantages of the invention will become apparent as the description proceeds.

### SUMMARY OF THE INVENTION

The present invention provides a method for reducing the cost of handling incoming/outgoing calls comprising:

a) providing a plurality of communication centers in data communication with one another, each of said communication centers being deployed in a different geographical region and adapted to interface with transmittable voice mailboxes, wherein one of said communication centers is designated as a default communication center for a given group of subscribers and the remaining communication centers being designated as distant communication centers;

b) making an agreement with a plurality of service providers of different telephone networks which allows said plurality of communication centers to use the receiving and transmitting infrastructure of each of said service providers,

c) routing incoming/outgoing calls associated with a given subscriber by said default communication center to a distant communication center via an optimal path through the infrastructure of each of said service providers; and

d) accessing the incoming/outgoing calls by an accession code.

The term “call,” as referred to herein, means a communication link which is transmitted between two parties via a telephone network, wherein the recipient may communicate in real-time with the initiator of the call, e.g. a telephone conversation, or the recipient may retrieve a call which has been recorded, e.g. in the database of a voice mailbox. A “telephone network” includes a conventional wire lined telephone network with an exchange and switches, a cellular network, a fiber-optic network, and an Internet network.

The term “infrastructure,” as referred to herein, means equipment, structures and cables installed by a service provider to allow for effective and efficient transmission and receiving of calls.

The optimal path is determined by the default communication center after compiling, for the given time of the call, the usage cost and transmission delays of the infrastructure of each service provider with which it has a working agreement and a list of possible communication paths from the default communication center to the distant communication center. The transmission time and cost of call is determined for each communication path, and an optimal path is then selected from the list of possible communication paths.

In one aspect, the cost of handling a call is reduced by selecting an Internet-based portion of the communication path-hereinafter referred to as a “segment”—through which the call is transmitted; encoding said call to Voice-over Internet Protocol (VoIP) by the communication center closest to a transitional point between a cable-based segment and an Internet-based segment; and decoding said call to an audio signal by the communication center closest to the end of said Internet-based segment. The provider by not having to pay to a service provider the operational costs associated with the usage of a cable-based segment.

In one aspect, the cost of handling a call to a cellular telephone is reduced by switching the communication path from a telephone network to a wireless network and transmitting the call via a last segment of the communication path in wireless fashion at non-chargeable radio frequencies, e.g. ranging between approximately 2.35-2.45 MHz. The provider is therefore afforded savings by eliminating airtime charges during the last segment.

A transmittable voice mailbox is a database which stores voice mail transmitted via different telephone networks and which may be transmitted entirely to a distant communication center, upon request by a subscriber. All voice mail messages may be retrieved during any retrieval session. Preferably, the voice mail transmitted via each telephone network is grouped separately, so that a voice menu directs the subscriber, at the commencement of a retrieval session, to retrieve any desired group of mail.

In one embodiment, all outgoing calls placed by subscribers are received by the default communication center, and each call is routed along an optimal path for that call, based on the phone number of a corresponding intended recipient.

In another embodiment, the default communication center routes calls based on instructions transmitted thereto by a subscriber.

In one aspect, a voice mailbox is routed by performing the following steps: transmitting a textual message from the subscriber to the default communication center, indicating access information of the subscriber and instructions as to which telephone the calls are to be accessed; determining the optimal path from the default communication center to the distant communication center closest to the instantaneous location of the subscriber; forwarding the voice mailbox to the distant communication center via the recently determined optimal path; and accessing the distant communication center by placing a local call and thereby retrieving his voice mailbox.

The term “textual message,” as referred to herein, means a textual communication link effected from afar between two parties, such as between the subscriber and default communication center, in a much more economical fashion than by a call transmitted in a cellular network. Examples of a message are a Short Message Service (SMS) and an e-mail message. A “voice message,” as referred to herein, means an audible message stored in a voice mailbox.

Preferably, a textual message is transmitted in return to the subscriber by the default communication center, to indicate that said voice mailbox has been forwarded to the distant communication center and may be accessed by the indicated telephone.

Preferably, a subscriber determines which voice messages to access from the voice mailbox by reviewing an additional textual message which is transmitted to the subscriber, said additional textual message listing, for each voice message stored in the voice mailbox, the telephone number which transmitted a given stored voice message and the duration of said stored voice message.

In another aspect, an incoming call is routed upon the transmission of a textual message by the subscriber to the default communication center, instructing thereby that incoming calls to his cellular telephone, which is used by another party to transmit outgoing calls, will be directed to a desired telephone number and that if the subscriber does not receive the call, a voice message will be recorded in his voice mailbox.

In another aspect, an outgoing call is placed by a traveling subscriber by performing the following steps: transmitting a textual message from the subscriber to the default communication center, indicating access information of the subscriber and instructions concerning from which telephone number and from which geographical location the call is to be placed; transmitting a command by the default communication center to the distant communication center closest to the instantaneous location of the subscriber to route an outgoing call; determining the optimal path for the outgoing call; transmitting a textual message from the default communication center to the subscriber that a communication line is available from said distant communication center; accessing the distant service provider; and placing an outgoing call. The destination of the outgoing call may be local with respect to said distant communication center.

In another aspect, a previously established optimal path remains in a communicable standby mode upon termination of a first outgoing call, said previously established optimal path being activated by the default communication center if the subscriber places a second outgoing call during a predetermined period of time following termination of the first call.

In another aspect, the subscriber transmits a textual message to the default communication center to initiate a callback mode. In the callback mode, the default communication center performs the following steps: repeatedly redials the number of an intended recipient until a communication line becomes available; transmits a pre-recorded voice message to the intended recipient in which the name of the subscriber and pertinent contact information are mentioned; and transmits a request for the intended recipient of the call to communicate with the subscriber. If the recipient desires, he may call the subscriber directly, to the phone number mentioned in the pre-recorded voice message. If he prefers not to call the subscriber directly, e.g. the subscriber is overseas, the recipient transmits a textual message to the default communication center, if he desires not to call the subscriber directly, wherein he indicates that his communication line is now available; the default communication center communicates with the distant communication center closest to the instantaneous location of the subscriber, commanding said distant communication center to link the subscriber with the intended recipient; the cellular telephone of the subscriber receives a voice message indicating that a communication line became available; the subscriber accesses said distant communication center; and the subscriber speaks with the intended recipient.

Alternatively, the default communication center transmits to a specified phone number, after a request to initiate the callback mode, a menu of available services and information-related options, e.g. placing an outgoing call, retrieving voice mail, and reviewing news, stock market, or weather information, and the subscriber indicates which option he desires to activate. In order to utilize his time more efficiently, the subscriber may transmit to the default communication center a message which specifies a preselected option, whereupon the default communication center transmits to the specified phone number voice and/or graphical information based on said preselected option.

In another embodiment of the invention, the default communication center performs self-billing functions. The default communication center determines relevant billing information concerning each subscriber in real-time and transfers said billing information to the provider.

As referred to herein, “provider” means the entity which provides access of the default and distant communication centers to the subscribers. At any given time, a communication center may be both a default communication center to one group of subscribers and a distant communication center to another group of subscribers. The provider allocates the resources for each communication center so that each subscriber may quickly and inexpensively place and receive calls.

In one aspect, the default communication center determines whether the debits of a subscriber are greater than a predetermined value, and then prevents the subscriber from receiving any incoming calls or placing outgoing calls or initiating a callback mode until a payment is made to the provider.

The present invention also provides a short-range wireless communication system for reducing the cost of handling incoming/outgoing calls, comprising a cellular telephone provided a first transceiver for transmission over a cellular network and a second transceiver for short-range wireless transmission, such as a Bluetooth transceiver; a dongle interfacing with a dedicated subscriber computer; and an earpiece,

wherein the dongle and earpiece are provided with short-range wireless transceivers and are in data communication with the second transceiver of the cellular telephone,

the subscriber computer being in communication with a plurality of communication centers in data communication with one another, each of said communication centers being deployed in a different geographical region and granted permission to use the receiving and transmitting infrastructure of a corresponding service provider, one of said communication centers being designated as a default communication center for a given group of subscribers and the remaining communication centers being designated as distant communication centers;

said default communication center suitable for routing incoming/outgoing calls associated with a given subscriber to a distant communication center via an optimal path through the infrastructure of each of said service providers.

### BRIEF DESCRIPTION OF THE DRAWINGS

In the drawings:

FIG. 1 is a schematic drawing of an exemplary routing of a call by a communication center deployed in Italy, in accordance with the present invention;

FIG. 2 is a schematic drawing of a cellular network, showing the transferring of a call from a base station to a communication center;

FIG. 3 is a schematic drawing of a communication center which comprises three separate servers, each of which being in communication with a different telephone network;

FIG. 4 is a flow chart of the various steps needed to route a voice mailbox;

FIG. 5 is a block diagram of various options that a communication center provides; and

FIG. 6 is a schematic diagram of a short-range wireless communication system that communicates with a communication center via the Internet.

### DETAILED DESCRIPTION OF PREFERRED EMBODIMENTS

The present invention is a method for reducing the cost of telephone calls, particularly those transmitted through a cellular network. The cost of placing a call is significantly reduced as a communication center routes the call, in the most economical fashion, through existing infrastructure installed and maintained by other parties. The communication center is in communication with a plurality of voice mailboxes, each of which may be remotely programmed by a different subscriber, whereby message destination and call initiation instructions may be received and performed.

Each communication center may serve for directing calls and as a means for self-billing, as will be explained hereinafter, and therefore the cost of placing a call is further reduced.

As is well known, each service provider of a telephone network, whether landline, international or cellular, has invested a considerable of money in the necessary infrastructure needed to allow subscribers to effectively and rapidly place a call to a desired destination. The infrastructure typically includes coaxial or fiber-optic cables, switching offices, digital concentrators, optical regenerators and receivers for fiber-optic cables, base stations having a tower and communication equipment for each cell of a cellular network, etc. Payments made to a service provider generally include a sum which helps to fund the capital costs invested within said infrastructure.

The cost of handling incoming/outgoing calls is significantly reduced by the provider of a transmittable voice mailbox (hereinafter referred to as “provider”), in accordance with the present invention, by obviating the need of funding the capital costs of service providers. The provider functions as a reseller by making a working agreement with service providers, whereby the communication center of the transmittable voice mailboxes is allotted blocks of time to utilize the infrastructure of the given service provider. By making an agreement with many different service providers, each of which is located in different locations, and even in different countries, the communication center may route calls through many different paths. The communication center determines, for the given time of the call, the usage cost of the infrastructure of each service provider with which it has a working agreement. The communication center then determines the optimal path for the call, taking into account transmission delays and the usage costs for each infrastructure through which the call is to be transmitted.

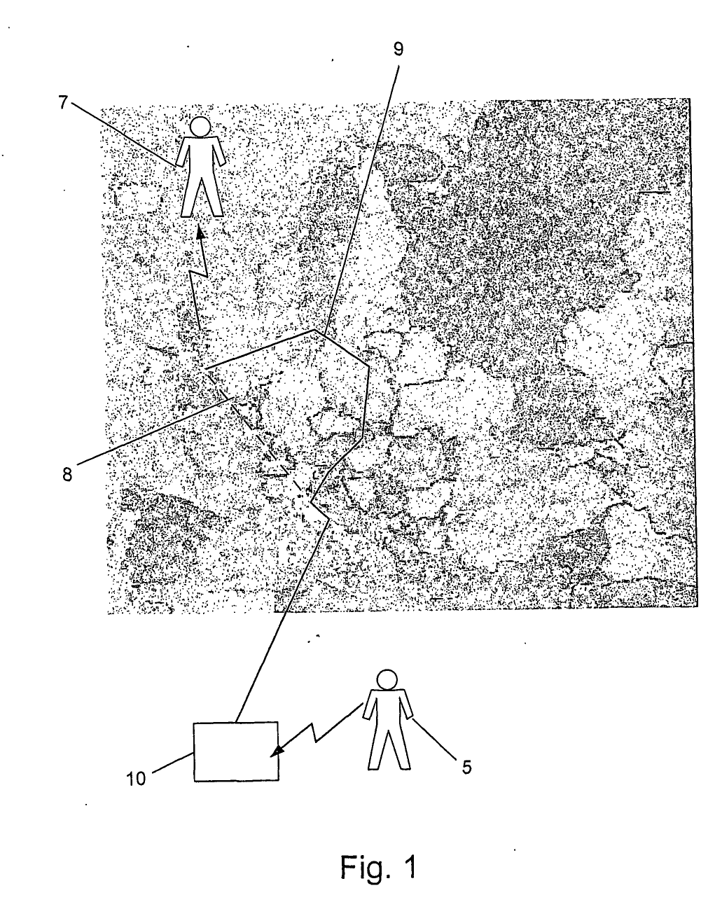

FIG. 1 illustrates an exemplary routing of a call by communication center 10 deployed in Italy, which is the sole provider of telephone service to subscribers of a transmittable voice mailbox (hereinafter referred to as a “subscriber” or “subscribers,” for brevity) located in a given geographical location in Italy. After subscriber 5 accesses communication center 10 by inputting his password and dials the phone number of a recipient 7 located in England with whom he wishes to communicate during the daytime, the communication center compiles a list of various communication paths. The most direct path, as indicated by numeral 8, is from Italy, Switzerland, France, and then to England. However, this route may be more expensive than a more circuitous route, such as from, Italy, Slovenia, Hungary, Slovakia, Poland, Sweden, Denmark, and then to England, as indicated by numeral 9. Communication center 10 determines the optimal path within a fraction of a second following transmission of the phone number of recipient 7, and then transmits the call along this path.

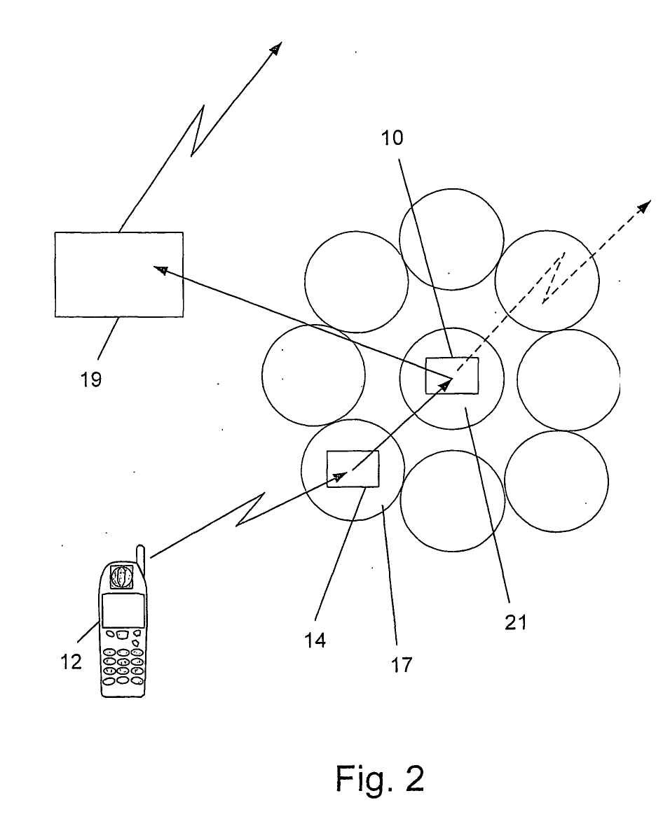

Referring now to FIG. 2, large savings may be realized when communication center 10 transmits a call through a cellular network, for which a subscriber normally has to pay for both landline time and airtime. The provider preferably has a working agreement with the service provider of a cellular network whereby calls are forwarded to communication center 10 upon detection that a subscriber has initiated a call. Without intervention of the provider, a call initiated from cellular phone 12 would be transferred to base station 14, located within cell 17 which is the cell closest to phone 12, and then to regional switching station 19, which monitors and controls the various base stations associated with the switching station, before being transmitted to the intended recipient, resulting in expensive airtime costs. However, since the service provider determines that phone 12 belongs to a subscriber, the call is transferred to base station 14 and then to communication center 10 located within cell 21, which is proximate to cell 17, before being routed on an optimal path, as described hereinabove, to the intended recipient.

Additional savings may be realized when communication center 10 transmits an international or long distance call. Instead of transmitting a call solely through coaxial or fiber-optic cables as has practiced heretofore in the prior art, a portion of the communication path (hereinafter referred to as a “segment”) through which the call is transmitted may be selected to coincide with the Internet. A call that is transmitted via an Internet network segment is encoded to Voice-over Internet Protocol (VoIP) and compressed by the communication center closest to the transitional point between a cable-based segment and an Internet-based segment. Likewise the call in digital form is decoded back to an audio signal by the communication center closest to the end of the Internet-based segment. The provider is therefore afforded savings by not having to pay to a service provider the operational costs associated with the usage of a cable-based segment.

The provider compiles, for each geographical location whereat a communication center is deployed, the estimated times during when Internet load is minimal. During these periods of minimal Internet load, the synchronization of VoIP packets being transmitted via an Internet-based segment, and consequently the voice quality of the call, is the greatest. Accordingly, the default communication center determines, following the placing of a call and determination of an optimal communication path, at which points along the optimal communication path the call is suitable for being converted to VoIP.

Further savings may be realized, when placing an outgoing call to a cellular telephone, by transmitting the last segment of the communication path, normally referred to as the last mile, in wireless fashion at widely accessible radio frequencies, e.g. ranging approximately between 2.35-2.45 MHz. Users that transmit signals at such frequencies do not incur transmission charges, and the provider therefore may eliminate airtime charges during the last mile by transmitting the call from the base station to the intended recipient at such frequencies. The communication center deployed proximate to the last segment switches the communication path from a telephone network to a wireless network. The call is transmitted along the last segment by means of an antenna deployed at the local base station, with permission from the service provider thereof.

After establishing an optimal path as described hereinabove enabling a subscriber to place an outgoing call, the provider may retain the optimal path in a standby mode upon termination of the call. Instead of having to incur the costs associated with the determination of an optimal communication path, the initialization of the path, and the switching from one segment to another, etc., the previously established optimal path, remains in a communicable standby mode for a predetermined period of time, e.g. 20 seconds, following termination of a previous call by the subscriber. The majority of the previously established optimal path, with the exception of the final segments thereof, by which the previous call was transmitted from the final communication center to the recipient of the call, may be utilized. If the subscriber places a call to a different party during this predetermined period of time, the default communication center activates the previously established communication path and commands the final communication center to transmit the new call to a different recipient, e.g. via additional segments. Subscribers are charged a lower rate for placing calls within this predetermined period of time, as an incentive to retain a previously established communication path in a standby mode for as long as possible.

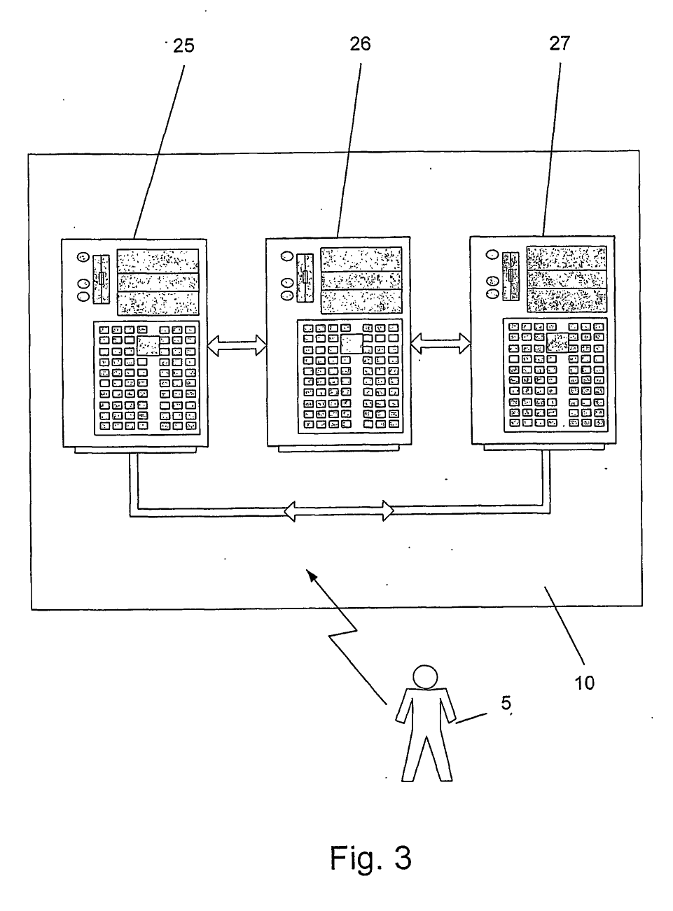

As schematically shown in FIG. 3, communication center 10 comprises a plurality of servers, e.g. servers 25, 26 and 27, each of which is in communication with voice mailboxes of a different telephone network and is situated in a different location. For example, server 25 communicates with a voice mailbox which receives and transmits personal calls, server 26 communicates with a voice mailbox which receives and transmits business-related calls, and server 27 communicates with a voice mailbox which receives and transmits calls within a cellular network, as depicted in FIG. 2. Although each server is physically distant from one another, the three servers are in mutual data communication, as indicated by the double arrows. That is to say, the database of recorded voice messages from each server is combined so that subscriber 5 may review all recorded voice messages at any retrieval session. Preferably the voice messages recorded by each server are grouped separately, so that a voice menu may direct the subscriber, at the commencement of a retrieval session, to retrieve any desired group of voice messages. Similarly, the voice mail may indicate whether a voice message is a new voice message, or may be characterized by any other categorization desired by the subscriber.

As previously described, the communication center also routes the incoming calls. To provide inexpensive communication and accessibility to a transmittable voice mailbox, the provider installs a communication center at each geographical location. Each communication center is in communication with each other, via the infrastructure of each service provider with which the provider has a working agreement. The communication center (hereinafter referred to as the “distant communication center”) which is distant from the default communication center of the subscriber may receive and transmit calls, in a similar fashion as the default communication center. As a result, a subscriber may access his voice mailbox, regardless of whether he is at home or abroad, by placing a local call.

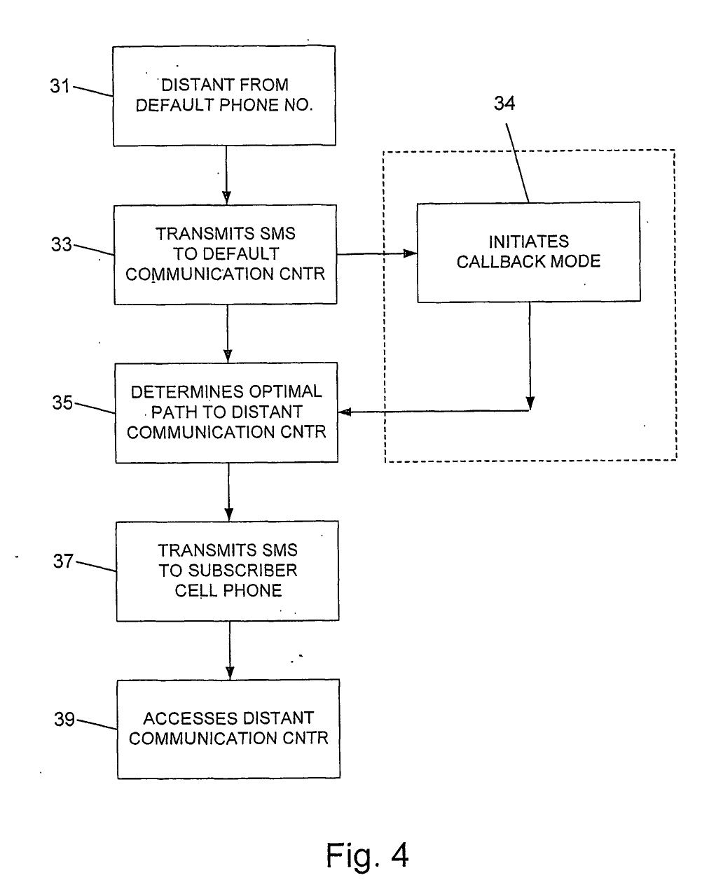

FIG. 4 is a flow chart of the various steps needed to route his voice mailbox. If the subscriber is distant from his default landline phone number, as indicated by step 31, he does not have to access his voice mailbox by a long-distant call, an international call, or by his cellular telephone. If the subscriber does not have access to a toll-free number, he may simply transmit in step 33 a Short Message Service (SMS), which is considerably more economical than any other form of long-distant communication within a telephone network, from his cellular telephone to his default communication center. In the SMS, the subscriber transmits his access information and instructions indicating from which landline telephone the voice mailbox is to be accessed. In step 35, the default communication center determines the optimal path, as described hereinabove, for routing the voice messages recorded in his voice mailbox. The recorded voice messages are then forwarded to the distant communication center via the recently determined optimal path. Accordingly, the default communication center transmits in step 37 an SMS in return to the subscriber, to indicate when his voice mailbox may be accessed by his temporary landline telephone. Finally, the subscriber accesses in step 39 the distant communication center by placing a local call, and therefore may retrieve his voice messages.

The default communication center may transmit, following step 37, an additional SMS which lists, for each voice message stored in the voice mailbox of the subscriber, the telephone number which transmitted the voice message and the duration of the voice message. A subscriber need not audibly review each voice message in serial fashion as has been practiced heretofore by prior art voice mail systems, but rather may selectively determine whether a voice message is of particular importance requiring immediate attention, while other voice messages may be listened to at a later time. A subscriber may also determine by a considerably short message duration of e.g. less than a second that the originator of a voice message terminated the voice message before leaving any voice information, and therefore need not access that terminated voice message. It will be appreciated that the subscriber may receive from a communication center not only voice messages, but also incoming calls.

For example, the subscriber may allow a family member to use his cellular telephone for outgoing calls, but may desire to receive the incoming calls transmitted via a cellular network at a desired telephone number. Accordingly, the subscriber transmits in step 33 a SMS to his default communication center, instructing thereby that incoming calls to his cellular telephone will be directed to a desired telephone number and that if the subscriber does not receive the call, a voice message will be recorded in his voice mailbox.

The default communication center co-ordinates all incoming and outgoing calls of the subscriber. The server of the appropriate telephone network transmits an outgoing call through the corresponding infrastructure of a service provider. The outgoing calls are routed via an optimal path, so that the subscriber will pay economical rates for outgoing calls. When the subscriber is distant from his default communication center, he may transmit a SMS message in step 33, instructing thereby that he desires to place an outgoing call from a specified telephone number at a given location. The default communication center accordingly communicates with a distant communication center closest to said given location, so that said distant communication center may establish an outgoing call via the infrastructure of the corresponding service provider. The cellular telephone of the subscriber may receive an SMS in step 37 when a communication line becomes available, after which the subscriber accesses said distant communication center in step 39. Alternatively, the subscriber may receive an incoming call from the distant communication center, inviting him to access a low cost local line, e.g., by pressing a predetermined key in his phone keypad. Upon pressing that key, the subscriber listens to the new dial tone that corresponds to said low cost local line, and then dials the desired overseas destination number, thereby initiating an overseas call at the cost of a local call. This outgoing call may also be placed locally, i.e. transmitted via the infrastructure of the distant service provider.

Travelers are dependant at times upon the services or advise of others. Occasionally, travelers need to constantly redial the number of the intended recipient until making contact with that person, e.g. a car towing agent or a stock broker. Aside from not properly utilizing valuable travel time, the repeated redialing of telephone numbers results in added costs, especially to those that are placing long-distance, international, or cellular network calls.

The use of the present invention may reduce such costs. By transmitting an appropriate SMS message in step 33, the subscriber programs the default communication center to initiate a callback mode in step 34, whereby the communication center repeatedly redials the number of the intended recipient until a communication line becomes available. As soon as the communication line becomes available, a pre-recorded voice message generated by the default communication center is transmitted to the intended recipient. In the message, the name of the subscriber and pertinent contact information are mentioned, and a request, for the intended recipient of the call to communicate with the subscriber, is made. If the recipient desires, he may call the subscriber directly, to the phone number mentioned in the pre-recorded message. If he prefers not to call the subscriber directly, e.g. the subscriber is overseas, the recipient may transmit a message to the default communication center wherein he indicates that his communication line is now available The default communication center accordingly communicates with the distant communication center closest to the instantaneous location of the subscriber, so that said distant communication center may link the subscriber with the intended recipient in step 35. The cellular telephone of the subscriber receives a SMS in step 37 indicating that a communication line became available, after which the subscriber accesses said distant communication center in step 39 and speaks with the intended recipient.

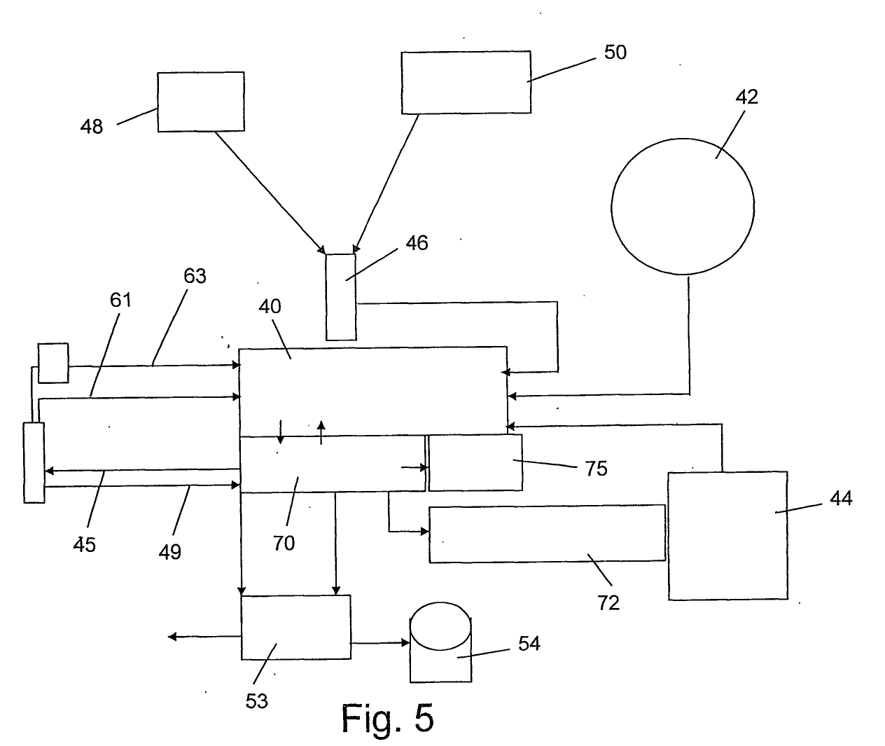

As shown in FIG. 5, the subscriber may interact with the default communication center, in order to obtain information which is not readily available, at a reasonable cost, at his distant location. The subscriber may access his default communication center 40 by a toll-free landline phone number 42, by a computer terminal 44 via the Internet network, or by a phone unit 46 distributed by the provider which is in communication with default communication center 40 via cellular network 48 or fiber-optic network 50. After the subscriber accesses default communication center 40, he hears a message listing various available options, e.g. outgoing call, voice mail, news, stock market, weather, etc. and the keys for activating each option. By depressing the appropriate key of the phone unit which he., is presently using, or alternatively, by means of voice recognition, the subscriber is able to indicate which option he desires to activate. Accordingly, he may place an outgoing call at 45, divert a call at 49, or retrieve voice mail 54 from his voice mailbox 53, as described hereinabove. If he so desires, he may activate, by example, the news option and obtain updated news from abroad concerning his home city. At any time, the subscriber may desire to personally communicate with a representative of the provider.

The menu may also be accessed in the callback mode. The subscriber may transmit an SMS at 61, in which message the subscriber indicates his access number and to which phone number default communication center 40 is to communicate. Default communication center 40 then determines the optimal path to the specified phone number, places a call to that number, and then the subscriber hears the menu of available information options, whereupon the subscriber selects an option, as previously described. In order to utilize his time more efficiently, the subscriber may transmit a detailed SMS at 63 in which the information option he wishes to access is preselected. For example, an exemplary transmitted message may be: “5555 CALL 1-212-999-9999 1234,” wherein 5555 represents his access code, CALL 1-212-999-9999 represents to which phone number the default communication center is to call, and 1234 represents the combination of preselected options the subscriber desires to activate. Consequently; default communication center 40 will call number 1-212-999-9999 and the subscriber will hear the available subject matter of the selected option upon receiving the call, without having to hear the various options that other subscribers hear when normally accessing the menu of options provided by the default communication center, and without having; to depress any input keys.

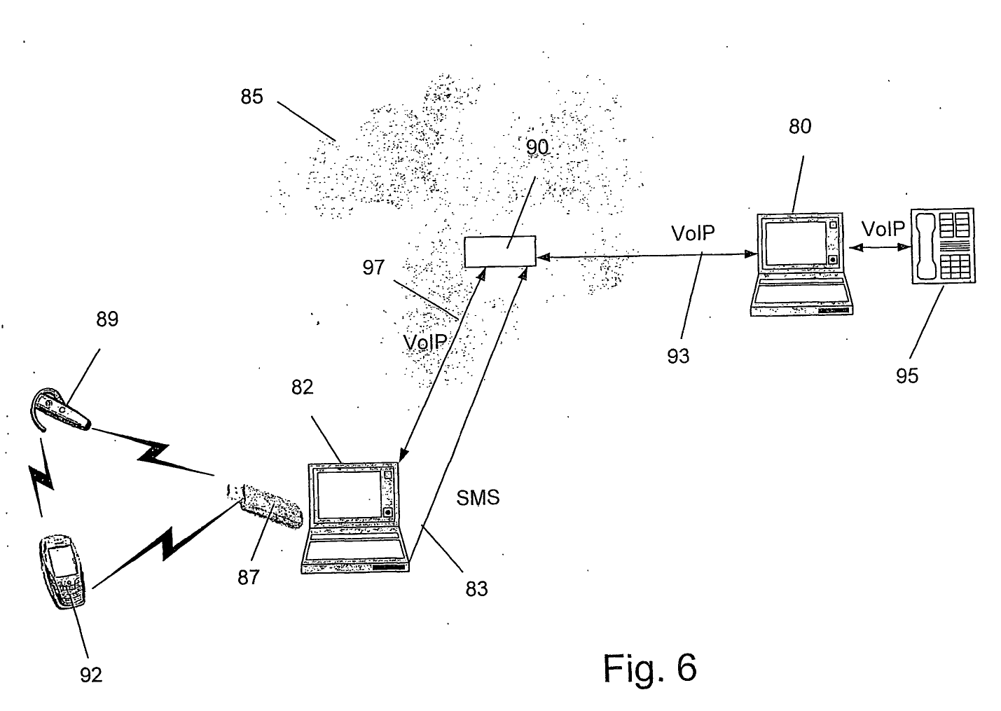

The callback mode may be implemented in conjunction with the Internet, as shown in FIG. 6 to further reduce the cost of handling a call. When a subscriber is located in proximity to his home or laptop computer, he may transmit an SMS via Internet-based and non-chargeable segment 83 from his cellular telephone 92 to default communication center 90, to initiate the callback mode. Default communication center 90 repeatedly redials the number of telephone 95 until segment 93 becomes available, whereupon a pre-recorded message containing contact information in VoIP format and associated with the subscriber is transmitted to recipient computer 80 and telephone 95. The recipient may call telephone 92 directly via a cellular network or via Internet 85 by means of the provider and communication center 90, if the recipient whose advice is requested is also a subscriber. Cellular telephone 92 is provided with two transceivers one for transmission over a cellular network and the other for short-range wireless transmission, such as a Bluetooth transceiver. The Bluetooth transceiver is in data communication with dongle 87, which is an electronic key that identifies both the phone number of cellular telephone 92 and the port address of subscriber computer 82 as well known to those skilled in the art, and with cellular telephone earpiece 89. Both dongle 87 and earpiece 89 are provided with Bluetooth transceivers.

Telephone 92 is set to a wireless mode by pressing a predetermined code on its keypad, e.g. ##*0097234445566#. Each wireless mode function, such as call transmission, call receiving, SMS transmission, SMS receiving, and toggling between cellular mode and wireless mode, is enabled by a: different code. When the wireless mode is activated, telephone 92 is interfaced by dongle 87 and then subscriber computer communicates with default communication center 90. Calls received by subscriber telephone 92 in the wireless mode are heard with earpiece 89. If the subscriber receives a call via the cellular network while engaged in a call transmitted from default communication center 90 in the wireless mode, as enunciated by the microphone of telephone 92, the subscriber may place the call transmitted from communication center 90 on hold and toggle from wireless to cellular mode. Likewise the subscriber may place a call transmitted from a cellular network on hold, in order to receive a call transmitted from communication center 90.

In another embodiment of the invention, a default communication center also provides billing services by means of account module 70. In contrast with the prior art in which a billing company independent from the service provider acquires data concerning destination, time and length of a call, resulting in higher costs to subscribers, the default communication center performs self-billing functions. As described hereinabove, the default communication center co-ordinates all incoming and outgoing calls of the subscriber. Therefore, all relevant billing information may be determined by default communication center 40 and transferred to the provider at 72, in order to charge the subscriber. Furthermore, the default communication center may determine whether the subscriber has an excessive amount of debits by means of credit check module 75. If the debits of a subscriber are greater than a predetermined value, the default communication center may prevent the subscriber, as established by the guidelines of the provider, from performing a function, such as making any outgoing calls, from receiving any incoming calls, or forwarding voice mailbox messages.

It will be appreciated that the subscriber may choose not to benefit from the various features described hereinabove, such as routing incoming/outgoing calls or voice messages, callback capabilities, more economical calls when traveling abroad, etc., that result in significantly reduced costs of handling calls. Nevertheless, a subscriber will benefit, from lower costs while using a standard retrievable voice mailbox since the billing is performed by the provider, in contrast to the prior art in which wherein a separate entity is needed.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Method for reducing the cost of handling incoming/outgoing calls comprising:
a) providing a plurality of communication centers in data communication with one another, each of said communication centers being deployed in a different geographical region and adapted to interface with transmittable voice mailboxes, wherein one of said communication centers is designated as a default communication center for a given group of subscribers and the remaining communication centers being designated as distant communication centers;
b) making an agreement with a plurality of service providers of different telephone networks which allows said plurality of communication centers to use the receiving and transmitting infrastructure of each of said service providers,
c) routing incoming/outgoing calls associated with a given subscriber by said default communication center to a distant communication center via an optimal path through the infrastructure of each of said service providers; and
d) optionally, accessing the incoming/outgoing calls by an accession code.

2. Method according to claim 1, wherein the optimal path is determined by the default communication center after compiling, for the given time of the call, the usage cost and transmission delays of the infrastructure of each service provider with which it has a working agreement and a list of possible communication paths from the default communication center to the distant communication center.

3. Method according to claim 2, wherein the default communication center determines the transmission time and cost of call for each possible communication path, and then selects an optimal path from the list of possible communication paths.

4. Method according to claim 1, wherein each transmittable voice mailbox stores voice mail transmitted via different telephone networks.

5. Method according to claim 4, wherein a voice mailbox is transmitted entirely to a distant communication center, upon request by a subscriber.

6. Method according to claim 4, wherein all voice mail is retrievable during any retrieval session.

7. Method according to claim 6, wherein the voice mail transmitted via each telephone network is grouped separately, whereby a voice menu directs the subscriber, at the commencement of a retrieval session, to retrieve any desired group of mail.

8. Method according to claim 1, wherein all outgoing calls placed by, subscribers are received by the default communication center, and each call is routed along an optimal path based on the phone number of a corresponding intended recipient.

9. Method according to claim 1, wherein the default communication center routes calls based on instructions transmitted thereto by a subscriber.

10. Method according to claim 9, wherein a voice mailbox is routed by performing the following steps: transmitting a textual message from the subscriber to the default communication center, indicating access information of the subscriber and instructions as to which telephone the calls are to be accessed; determining the optimal path from the default communication center to the distant communication center closest to the instantaneous location of the subscriber; forwarding the voice mailbox to the distant communication center via the recently determined optimal path; and accessing the distant communication center by placing a local call and thereby retrieving his voice mailbox.

11. Method according to claim 10, wherein a textual message is transmitted in return to the subscriber by the default communication center, to indicate that said voice mailbox has been forwarded to the distant communication center and may be accessed by the indicated telephone.

12. Method according to claim 9, wherein an incoming call is routed upon the transmission of a textual message by the subscriber to the default communication center, instructing thereby that incoming calls to his cellular telephone, which is used by another party to transmit outgoing, calls, will be directed to a desired telephone number.

13. Method according to claim 9, wherein an outgoing call is placed by a, traveling subscriber by performing the following steps: transmitting a, textual message from the subscriber to the default communication center; indicating access information of the subscriber and instructions concerning from which telephone number and from which geographical location the call is to be placed; transmitting a command by the default communication center to the distant communication center closest to the instantaneous location of the subscriber to route an outgoing call; determining the optimal path for the outgoing call; transmitting a textual message from the default communication center to the subscriber that a communication line is available from said distant communication center; accessing the distant service provider; and placing an outgoing call.

14. Method according to claim 13, wherein the destination of the outgoing call is local with respect to said distant communication center.

15. Method according to claim 9, wherein the subscriber transmits a textual message to the default communication center to initiate a callback mode.

16. Method according to claim 15, wherein the default communication center performs the following steps: repeatedly redials the number of an intended recipient until a communication line becomes available; transmits a pre-recorded voice message to the intended recipient in which the name of the subscriber and pertinent contact information are mentioned; and transmits a request for the intended recipient of the call to communicate with the subscriber.

17. Method according to claim 16, further comprising the following steps: the recipient transmits a textual message to the default communication center, if he desires not to call the subscriber directly, wherein he indicates that his communication line is now available; the default communication center communicates with the distant communication center closest to the instantaneous location of the subscriber, commanding said distant communication center to link the subscriber with the intended recipient; the cellular telephone of the subscriber receives a textual message indicating that a communication line became available; the subscriber accesses said distant communication center; and the subscriber speaks with the intended recipient.

18. Method according to claim 15, wherein the default communication center transmits to a specified phone number, after a request to initiate the callback mode, a menu of available services and information-related options, and the subscriber indicates which option he desires to activate.

19. Method according to claim 18, wherein the subscriber transmits to the default communication center a textual message which specifies a preselected option, whereupon the default communication center transmits to the specified phone number voice and/or graphical information based on said preselected option.

20. Method according to claim 1, wherein the default communication center performs self-billing functions.

21. Method according to claim 20, wherein the default communication center determines relevant billing information concerning each subscriber in real-time and transfers said billing information to the provider.

22. Method according to claim 21, wherein the default communication center determines whether the debits of a subscriber are greater than a predetermined value, and then prevents the subscriber from receiving any incoming calls or placing outgoing calls or initiating a callback mode until a payment is made to the provider.

23. Method according to claim 3, wherein the cost of handling a call is reduced by selecting an Internet-based segment through which the call is transmitted; encoding said call to Voice-over Internet Protocol (VoIP) by the communication center closest to a transitional point between a cable-based segment and an Internet-based segment; and decoding said call to an audio signal by the communication center closest to the end of said Internet-based segment.

24. Method according to claim 3, wherein the cost of handling a call to a cellular telephone is reduced by switching the communication path from a telephone network to a wireless network and transmitting the call via a last segment of the communication path in wireless fashion at non-chargeable radio frequencies

25. Method according to claim 24, wherein the call is transmitted at frequencies ranging from approximately 2.35 to 2.45 MHz.

26. Method according to claim 11, wherein a subscriber determines which voice messages to access from the voice mailbox by reviewing an additional textual message which is transmitted to the subscriber, said additional textual message listing, for each voice message stored in the voice mailbox, the telephone number which transmitted a given stored voice message and the duration of said stored voice message.

27. Method according to claim 1, wherein a previously established optimal path remains in a communicable standby mode upon termination of a first outgoing call, said previously established optimal path being activated by the default communication center if the subscriber places a second outgoing call during a predetermined period of time following termination of the first call.

28. A short-range wireless communication system for reducing the cost of handling incoming/outgoing calls, comprising:
a) a cellular telephone provided with a first transceiver for transmission over a cellular network and a second transceiver for short-range wireless transmission;
b) a dongle interfacing with a dedicated subscriber computer; and
c) an earpiece,
wherein the dongle and earpiece are provided with short-range wireless transceivers and are in data communication with the second transceiver of the cellular telephone;
wherein the subscriber computer is in communication with a plurality of communication centers in data communication with one another, each of said communication centers being deployed in a different geographical region and granted permission to use the receiving and transmitting infrastructure of a corresponding service provider, one of said communication centers being designated as a default communication center for a given group of subscribers and the remaining communication centers being designated as distant communication centers;
said default communication center suitable for routing incoming/outgoing calls associated with a given subscriber to a distant communication center via an optimal path through the infrastructure of each of said service providers.
